(19) United States
(12) Patent Application Publication
(10) Pub. No.: US 2010/0067637 A1
(43) Pub. Date: Mar. 18, 2010

(54) Apparatus and process for generating flow-stimulated nuclear heat

(76) Inventor: Talbot Albert Chubb, Arlington, VA (US)

Correspondence Address: Melvin L. Crane, 318 South Cleveland Street, Arlington, VA, 22204-2038, US

(21) Appl. No.: 12/283,794

(22) Filed: Sep. 17, 2008

(51) Int. Cl. H05H 1/22

(52) U.S. Cl. 376/100

(57) ABSTRACT

A deuterium-fueled heat generating reactor that uses a nanometal catalyst to promote an exothermic nuclear reaction, and which increases the reaction rate by using a cation-conducting solid-electrolyte electrochemical cell to pull deuterium flow through the catalyst bed in a closed-loop path.

### BACKGROUND OF THE INVENTION

1. Field of the Invention

This invention relates to heat generating processes, and more particularly to heat generating processes in which deuterium participates in exothermic nuclear reactions in condensed matter. Further, the invention is directed to low energy nuclear reactions taking place in condensed matter, which includes radiationless cold nuclear fusion and other nuclear transmutations.

2. Description of the Prior Art

The invention is an improvement over the apparatus and process used by Arata and Zhang in 2008 to demonstrate the release of nuclear fusion heat from a ZrO₂+nanoPd composite “nuclear” catalyst. The catalyst released heat in two steps after being subjected to pressurized D₂ gas. When first subjected to D₂ gas the catalyst increased in temperature in response to a chemical reaction that formed Pd deuteride PdDₓ, where x rose from 0 to about 2. The chemical reaction heat flowed from catalyst to the reactor wall and from the reactor wall to the surrounding area. This relatively short duration release of chemical heat was followed by a second period of heat release in which there was a multiple-day release of nuclear reaction heat, which similarly flowed from catalyst to reactor wall and from reactor wall through thermal insulation to room, showing almost no decrease in heat flow rate during a run lasting hundreds of hours. Measurement of post-run helium showed that the nuclear reaction heat was at least partially due to the nuclear fusion of deuterium to helium-4 (⁴He). The nuclear fusion reaction releases 10,000,000 times the energy per consumed fuel molecule than that released by chemical combustion. When Arata and Zhang substituted H₂ gas for D₂ gas, no multiple-day release of heat occurred, and no post-run ⁴He was observed.

Arata and Zhang performed cold fusion heat studies in 1992 using nanometer size Pd-black as a nuclear catalyst, and in beginning in 2002 performed studies using a catalyst containing nanometer Pd inside ZrO₂ crystals, designated ZrO₂+nanoPd. The reactor apparatus used in the studies carried out between 1993 and 2002 was a concentric double-vessel reactor with outer and inner vessels. Their process used an electrolysis cell filled with a heavy water (D₂O) electrolyte from which deuterium was plated onto the cylindrical surface of the inner vessel. The inner vessel had the form of a metal bottle with a cylindrical Pd wall through which deuterium diffused. Prior to 2002 deuterium emerging from the inside surface of the Pd metal made contact with, and was absorbed by a Pd-black catalyst. The apparatus was called a DS-cathode. The 2002 study with ZrO₂+nanoPd catalyst demonstrated 10 watts of excess heat power for 3 weeks, as calculated by subtracting electrolysis input power from outflow heat power.

In 2005 Arata and Zhang changed their process for electrolysis loading to gas loading. They removed the electrolyte from their electrolysis cell and replaced it with high pressure D₂ gas, but kept the concentric cylinder construction. During gas loading the D₂ molecules dissociated into D-atoms on the Pd cylinder which served as the cylinder wall of the reactor's inner vessel, designated “inner vessel”. The D-atoms diffused through the vessel's Pd wall and were absorbed by nanoPd catalyst contained within the inner vessel. Comparison tests were carried out using both Pd-black and ZrO₂+nanoPd catalysts. In all tests Arata and Zhang operated their “gas loading” reactor at ˜140° C. temperature, using an electrical heater in contact with the outer wall of the reactor to raise the reactor wall temperature to ˜140° C. before D₂ gas was used to fill the space between the inner and outer cylinders. In the 2005 study the nuclear heat power was demonstrated by examining the long-duration temperature difference between inner and outer vessels observed late in long duration runs. When D₂ gas was used to load Pd-black catalyst, the catalyst temperature was higher than the reactor wall temperature. When H₂ gas was used with Pd-black catalyst, the catalyst temperature was lower than the reactor wall temperature. The reversal in temperature difference showed that nuclear heat was being released inside the catalyst bed when D₂ gas was used, and not when H₂ gas was used.

Substitution of ZrO₂+nanoPd catalyst for Pd-black caused a factor of 8 increase in the temperature difference between catalyst and reactor wall. This increase was accompanied with an increase in reactor wall temperature that permitted calculation of the total nuclear output power. The increase in the difference between reactor wall temperature and room temperature means that an increase in heat flow through the insulation wrapping had occurred. The increase was equal to 33% of the temperature difference produced by the electrical heater used to maintain the ˜140° C. temperature prior to D₂ gas pressurization. Since the heater power required to maintain a steady ˜140° C. was measured to be 1.7 watts and the fusion heat component was 33% of this temperature-maintaining heater power, the fusion heat power could be calculated. The calculated fusion power was 0.6 watts.

The 0.6 watts of fusion heat from gas-loaded ZrO₂+nanoPd catalyst is much less than the 10 W obtained using electrolysis loading for roughly the same amount of catalyst. The higher heat flow obtained with electrolysis was due to flow stimulation. Steady Arata and Zhang electrolysis process causes a steady deuterium flow through the catalyst bed. The observed higher power output achieved using electrolysis demonstrates that deuterium flow through the catalyst stimulates higher nuclear heat output.

In a different context, the value of flow stimulation is shown in studies by McKubre et al. Their studies, cited as Prior Art, have shown episodic nuclear fusion heat release in bulk Pd metal, but only when there was a net flow of deuterium into and out of a Pd metal cathode, independent of direction. The value of flow stimulation was also shown in studies by Iwamura et al, (1998), cited as Prior Art. The Iwamura studies used a constant deuterium permeation flow through a Pd reactor plate containing a dispersion of CaO crystals. Their experiments showed nuclear heat release in Pd reactor plates containing embedded oxide and not when the CaO was omitted. Also, no nuclear heat release was seen when H₂ was used instead of D₂. The function of CaO crystals in the Iwamura et al. (1998) studies parallels that of ZrO₂ crystals in the Arata and Zhang (2002) study.

The prior art and the Arata and Zhang 2005 and 2008 studies show that significant nuclear heat power can be achieved within a catalytic nanoPd medium without imposing a continuing permeation deuterium flow through the reaction medium, but the level of heat power is lower than occurs when a continuing permeation flow is maintained within the catalytic medium. Deuterium flow has a stimulation effect. The apparatus and process of the invention provides controllable deuterium flow through a ZrO₂+nanoPd composite catalyst bed, adding a controlled flow stimulation heat addition to the nuclear reaction heat release present when no deuterium permeation flow is provided. The invention apparatus provides flow stimulation using closed-loop flow produced by using electrochemical means without the use of a mechanical pump. The electrochemical means includes moisture control and voltage limitation to ensure long life deuterium flow stimulation.

### SUMMARY OF THE INVENTION

The invention describes apparatus and process which causes deuterium to participate in exothermic nuclear reactions in a condensed matter environment. The process uses a reversible form of a solid state electrolytic cell similar to that used in unidirectional flow fuel cells. The electrolysis cell is used to remove D atoms from the bottom surface of an open-top catalyst reservoir containing a fusion-promoting catalyst bed. The solid state electrolytic cell functions as an electrically powered pump that drives a closed loop circulation of deuterium within a pressurized hermetically sealed reactor vessel. Deuterium flow downward through the catalyst bed stimulates additional nuclear fusion reactions, increasing the heat production rate that occurs when no deuterium flow is occurring.

### OBJECTS OF THE INVENTION

It is therefore an object of the invention to provide a device from which nuclear energy is released and converted to heat within a catalyst bed;

Another object of the invention is to provide heat from nuclear energy by use of nuclear reactions in which deuterium participates as a reactant;

Still another objective is to provide heat from nuclear energy without the emission of energetic particles, neutrons, or gamma radiation, such as accompanies heat generation in commercial nuclear power plants;

Yet another object is to provide heat from nuclear energy in a device that is small enough to be suitable for heating a room.

Another object is to enhance heat production over what occurs under static, no-deuterium-flow conditions.

### BRIEF DESCRIPTION OF DRAWINGS

FIG. 1 is a side view schematic cross sectional drawing of a reactor whose shape is that of a right circular cylinder.

FIG. 2 is a side view schematic cross sectional drawing of a reactor built in accord with FIG. 1 using a manufacturing design that permits simplified replacement of catalyst and which prevents accidental loss of catalyst from the catalyst bed. A needed moisture control subsystem illustrated in FIG. 1 is not shown in FIG. 2.

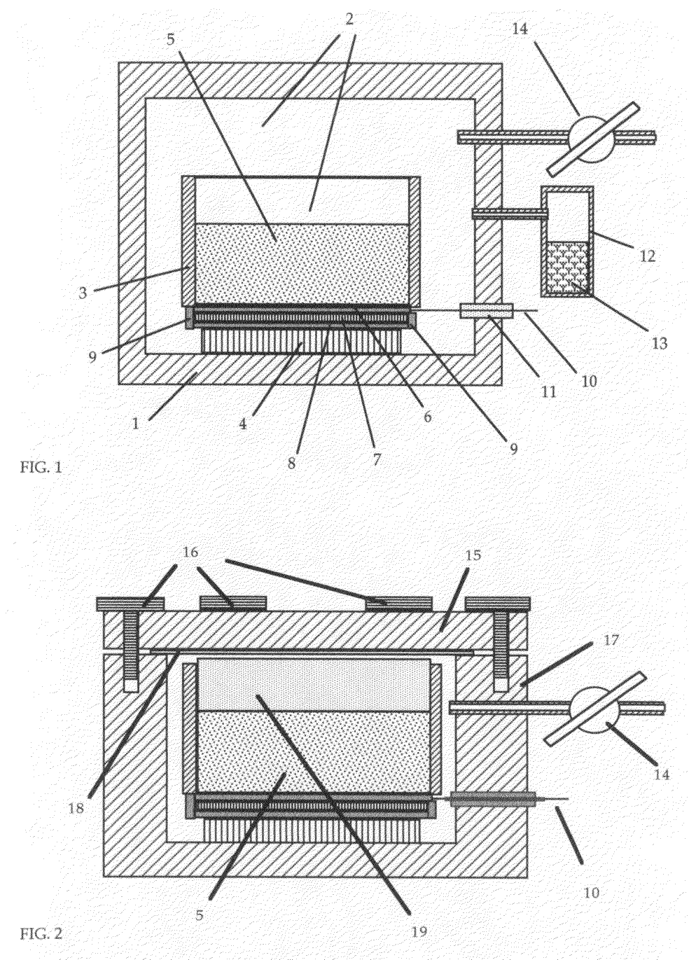

### DETAILED DESCRIPTION

The Apparatus is a dosed-cylinder catalytic nuclear reactor. The reactor vessel wall 1 includes therein moist D₂ gas 2 which fills the interior volume of the reactor vessel at a pressure in the range 2-100 atmospheres. Within the reactor vessel a cylindrical open-top container 3 formed of stainless steel is partially filled with catalyst bed 5 that promotes a 2 D₂→⁴He nuclear fusion reaction. Porous support disk 4 indirectly structurally supports open-top container 3, provides electrical contact between an electrolysis cell bottom plate 8 and reactor vessel wall 1, and provides gas 2 access to the electrolysis cell bottom plate 8. Catalyst bed 5 is filled with a catalyst containing a nanometal component that promotes a deuterium nuclear fusion reaction. Bottom plate electrode 8 of an electrolysis cell containing solid electrolyte 7 converts deuterium from D-atom form to D₂ gas form, and provides for moisture transport between portions of its bottom surface and its top surface. Top plate electrode 6 removes D₂ gas from catalyst bed 5, converts it to D-atom form, and serves as the anode of the electrolysis cell. Annular support rim 9 seals-off the edges of the electrolysis cell, and contact wire 10 makes electrical contact between top plate electrode 6 of the electrolysis cell and the positive terminal of an external source of electrical power, not shown. Contact wire 10 passes through hermetically sealed insulator 11, which passes through reactor wall 1. The external source of electrical power provides a voltage potential between contact wire 10 and reactor wall 1. Electrical potential is limited to the range 0-1.2 volt to avoid the electrochemical dissociation of dissolved water in solid electrolyte 7. A reservoir 12 contains a supply of heavy water or deuterated salt 13, and maintains moisture in the deuterium gas 2 within the reactor vessel. Reservoir 12 connects to the interior volume of the reactor vessel via a tube as shown. D₂ gas can be added to the vessel via a gas connection input tube 14 from a D₂ reservoir not shown. A control valve is shown in the gas connection input tube.

The flow-stimulated catalytic nuclear reactor is an apparatus that supports a catalytic fusion reaction liberating heat that flows through the reactor wall 1 to the surrounding area. In this process, the reactor functions as a heater which heats its surroundings. The nuclear reaction is catalyzed by nuclear-reaction catalyst 5. Nuclear-reaction catalyst 5 has been used as the active component in a gas-loaded deuterium fusion reactor as described in Arata and Zhang (2008). The improved catalytic reactor adds a deuterium fluxing capability to the Arata and Zhang 2008 reactor. The deuterium fluxing device is driven by an electrolysis-cell “pump”, which drives a closed-loop circulation of deuterium through the catalyst material without the use of mechanical pumping, and in a manner that enables operator control of deuterium fluxing velocity. In a preferred implementation, the flow direction through catalyst bed 5 is downward.

During downward flow of D₂ gas 2 through catalyst bed 5, D₂ gas makes contact with top plate electrolysis electrode 6. Top plate 6 is made positive relative to reactor wall 4 and bottom electrolysis plate 8, and functions as an electrolysis cell anode. Functioning as a fuel cell anode, top plate 6 first converts D₂ gas formed at the bottom surface of catalyst bed 5 to surface atom form. The atoms diffuse downward through top plate 6 so as to make contact with solid electrolyte 7. Each D atom then loses an electron and becomes a D+cation, which dissolves inside solid electrolyte 7. Solid electrolyte 7 is a cation conductor. The D⁺ ions, aided by an electric field, flow through solid electrolyte 7, make contact with bottom electrode 8, diffuse through bottom electrode 8, and recombine on the bottom surface of electrode 8 to form D₂ gas at a higher pressure than in gas volume 2. Gas 2 then flows through porous support disk 4 to join D₂ gas 2.

A solid electrolyte cell comprises top electrode 6, solid electrolyte 7 and bottom electrode 8. To sustain downward flow, a positive potential is applied to electrode 6 by contact wire 10 that passes through feed-through insulator 11 and connects to an external power supply (not shown) whose voltage should be kept below 1.2 volts. This restriction prevents production of O₂. Proper operation of solid electrolyte 7 requires that its internal moisture be above a minimum concentration. Heavy water D₂O 13 in liquid or chemical form is contained in reservoir 12. By controlling the temperature of reservoir 12, a desired amount of D₂O vapor is present in the circulating D₂ gas 2. An external temperature control system (not shown) is used to control the D₂O vapor pressure within enclosure 12. Enclosure 12 connects by tubing to reactor gas 2. Fuel cell cathode 8 is manufactured so as to have some gas porosity. If the cell is operated at excessive voltage and solid electrolyte 7 becomes too dry. Deuterium flow can be temporarily slowed to balance diffusion of moisture to solid electrolyte 7.

Reactor volume 2 is connected by tubing to an external gas/vacuum manifold system (not shown) by valve and tubing assembly 14. During pre-operation preparation, external manifold is connected to a vacuum and reactor valve is opened so as to remove all gas and contaminants from nuclear catalyst 5 and other parts of the reactor interior. The manifold is then adjusted to supply an inflow of D₂ gas. As the D₂ pressure builds up inside reactor wall 1, deuterium is absorbed inside catalytic reactor bed 5. A release of chemical heat of reaction occurs during this period, and the heat flows away to the reactor surroundings. After the chemical reaction heat is largely dissipated, the reactor is pressurized to a desired pressure of typically 20 atmospheres. Valve 14 is closed. Nuclear fusion reaction at a relatively low rate has begun during this preparation period. Electrical power is then applied to the electrolysis cell, items 6+8+7, and closed-loop deuterium circulation begins. The flow of deuterium through the nuclear catalyst bed then induces small momentum shocks within the interfaces between the nanometal grains and contacting ionic crystals. The shocks are caused by near-instantaneous momentum changes that occur when permeating deuterons change from atom-like geometry to the quasiparticle geometry that characterizes metal electrons. The shocks stimulate the fusion reaction step, increasing the fusion rate in response to operator control. The reactor functions as a flow-stimulated gas-loaded deuterium fusion reactor.

In a preferred embodiment bottom plate electrode 6 and top plate 7 electrode are made of Nafion+platinum composite, and solid electrolyte 8 is a Nafion polymer, as developed and sold by Dupont Corporation. Nuclear catalyst 5 is a ZrO₂+nanoPd composite manufactured in accordance with a protocol developed at the Institute for Materials Research at Tohoku University, and described by Yamaura et al, (2002), cited as Prior Art.

Variations of the invention include modifications related to desired power level and output temperature. Reactor size can be varied from cm-scale reactor radius for room heater application to multi-meter reactor radius for industrial heat or power plant application. Choice of operating temperature is limited by available materials and required lifetime. The preferred solid electrolyte and catalyst are functionable from ˜25° C. to ˜200° C. Use of deuterium flow through multiple catalyst bed assemblies connected in series and/or parallel configurations are plausible extensions of the specified apparatus. Materials used for reactor wall and internal support can be selected from materials other than stainless steel, e.g., aluminum, titanium, stable plastics, and ceramics. It can be expected that alternate catalysts and solid electrolytes will be developed. Reactors can be wrapped with thermal insulation to change the rate that heat is delivered to the environment, or to achieve a higher operating temperature at a given power output.

Referring to FIG. 2, operation of the reactor depends on construction details regarding the manufacture of reactor vessel wall 1, and depends on whether the operator requires protection against accidental spilling of catalyst powder out of open-top container 3. If the operator anticipates catalyst replacement, the top wall of reactor vessel wall 1 can be made removable by manufacturing it as a two-piece assembly with a removable flat plate 15 fitted with bolt holes through which assembly bolts 16 can be inserted so as to attach it to the edge of open-end cylinder portion 17 of the reactor vessel wall 1. Threaded bolt holes in the upper edge of the cylinder portion 17 of reactor vessel wall 1 are made so as to receive the assembly bolts 16. A gasket 18 is provided to form a gas tight seal, thereby ensuring a hermetically tight reactor vessel after assembly.

Assembly steps start with reactor vessel wall 1 in disassembled condition. Steps are: 1) pour a weighed amount of nanoPd catalyst into open-top container 3 to create catalyst bed 5; 2) assuming that operator wishes to guard against catalyst spill, place an anti-spill porous plate 19 on top of catalyst bed 5; 3) position gasket 16 on the top edge of cylinder portion 12 of reactor wall 1, position flat plate 15 over gasket 18, and insert bolts 16 through the bolt holes so as to enter tapped holes in cylinder portion 17; 4) tighten the bolts so as to compress the gasket; 5) remove air from the hermetic reactor vessel by opening valve 14 so as connect the reactor to an external gas manifold configured to provide connection to an actively pumped vacuum; 6) close valve 14 and reconfigure the manifold to provide connection to a source of D₂ gas; 7) open valve 14 to fill the evacuated reactor with D₂ gas to a desired pressure; 8) connect an external power supply to the reactor so as to provide a voltage difference between contact wire 10 and reactor vessel wall 1; 9) adjust the external power supply so as to drive a desired rate of deuterium closed-loop circulation flow.

What is claimed:

1. Apparatus and process for generating heat by exothermic nuclear reactions in which deuterium participates, comprising a reservoir, evacuating the reservoir, filling the reservoir with a deuterium gas, in which the deuterium gas at an upper portion of the gas-filled reservoir flows downward into a reservoir containing nanometal catalyst which promotes an exothermic nuclear reaction, the deuterium gas then flows downward into a polarized electrolysis cell including a top electrode positive relative to a bottom electrode with an electrically polarized solid electrolyte between the top electrode and the bottom electrode with the electrolyisis cell containing a solid electrolyte therein, the deuterium gas then flows downward out of the electrically polarized solid-electrolyte layer, through the bottom electrode which is secured to the bottom of the gas filled reservoir by a porous support plate, and into a bottom volume of the gas filled reservoir, so as to participate in a closed loop circulation flow.

2. The apparatus and process of claim 1 in which the nuclear catalyst is a ZrO₂+nanoPd composite.

3. The apparatus and process of claim 1 in which the solid electrolyte of the electrolysis cell is made of a Nafion polymer.

4. The apparatus and process of claim 1 in which the nuclear catalyst is an ionic crystal+nanoNi composite.

5. The apparatus and process of claim 1 in which the top electrode of the electrolysis cell may be more or less positive relative to the bottom electrode, which results in an alternately stronger or weaker downward flow of deuterium gas through the nanometal nuclear catalyst.

6. The apparatus and process of claim 5 in which the nuclear catalyst is a ZrO₂+nanoPd composite.

7. The apparatus and process of claim 5 in which the solid electrolyte of the electrolysis cell is made of a Nafion polymer.

8. Apparatus and process for generating heat by exothermic nuclear reactions in which deuterium participates, and in which deuterium gas at a bottom portion of a gas filled reservoir flows into a polarized electrolysis cell including a top electrode negative relative to a bottom electrode and containing a solid electrolyte between the top and bottom electrode, the deuterium gas then flows upward out of an electrically polarized solid-electrolyte layer into a reservoir containing a nanometal nuclear catalyst that promotes an exothermic nuclear reaction, and in which apparatus most of the deuterium flows upward out of the vessel containing the nuclear catalyst into the gas filled reservoir so as to participate in a dosed loop circulation flow.

9. An apparatus for generating heat by exothermic nuclear reactions which comprises;
a closed-cylinder housing which forms a cylinder chamber 1 that encloses a D₂ gas, means for evacuating the cylinder chamber, means for adding D₂ gas into the chamber;
a cylindrical open-top container 3 supported within said cylinder chamber; said open top container includes therein a catalyst bed 5 that promotes a 2 D₂→⁴He nuclear fusion reaction;
a porous support disk 4 that supports the open top chamber within the cylinder chamber;
a solid electrolyte cell comprising a top electrode 6, a solid electrolyte 7 and a bottom electrode 8 formed between the catalyst bed 5 and the porous support plate 4; and a contact wire 10 which passes through an insulator 11 in a chamber wall and connects with the top electrode 6 and connects to an electrical source outside the chamber 1 which supplies electrical energy to the electrode 6.

10. An apparatus as set forth in claim 9, which comprises; a reservoir 12 outside of said cylinder chamber;
said reservoir 12 contains heavy water D₂O 13 in liquid or chemical form for supplying D₂O gas to the chamber formed by the housing; and a tube assembly which connects with the chamber through a wall of the housing for evacuating the chamber and for adding D₂ gas thereto.
